(19) United States
(12) Patent Application Publication
(10) Pub. No.: US 2025/0104262 A1
(43) Pub. Date: Mar. 27, 2025

(54) ACQUIRING HEAD DIMENSIONS USING COMMON DEVICES

(71) Applicant: ZAM Helmets Inc., Redwood City, CA (US)

(72) Inventor: David Stoutamire, Menlo Park, CA (US)

(21) Appl. No.: 18/891,034

(22) Filed: Sep. 20, 2024

Related U.S. Application Data
(60) Provisional application No. 63/539,683, filed on Sep. 21, 2023.

(51) Int. Cl. G06T 7/62; G06T 7/50; G06T 17/00

(52) U.S. Cl. CPC G06T 7/62; G06T 7/50; G06T 17/00; G06T 2207/20084

(57) ABSTRACT

Provided is a non-invasive method to obtain head dimensions utilizing everyday electronic devices, like cell phones or tablets. By positioning the back of the user's head against a flat surface and capturing images, the method uses machine learning models to provide sufficiently precise measurements, particularly along the front-back axis, overcoming challenges posed by hair coverage. This facilitates the creation of custom-fit head-worn devices such as helmets, or size recommendations for head-worn devices, without specialized equipment.

### CROSS-REFERENCE TO RELATED APPLICATIONS

This application claims the benefit of U.S. Provisional Patent Application Ser. No. 63/539,683 filed on Sep. 21, 2023, the disclosure of which is incorporated herein by reference as if explicitly set forth.

### BACKGROUND

Consumer products such as sports helmets ensure the safety and comfort of users. However, the current market predominantly offers helmets in limited sizes like small, medium, and large. While these helmets come with mechanisms like interior padding and adjustable circumferential bands for fit customization, the static size categories can result in helmets that are unnecessarily heavy and bulky. Modern manufacturing processes that use additive and subtractive techniques facilitate customization based on precise head dimensions, but obtaining these measurements is often invasive or requires specialized equipment.

### BRIEF DESCRIPTION

This application relates generally to the field of personalized measurement technologies and, more specifically, to a method for acquiring head dimensions remotely using commonly-owned electronic devices. This is particularly relevant for the design and manufacturing of consumer safety products, such as custom-fit sports helmets, where accurate head measurements are relevant to ensuring both comfort and safety of the user. The method further offers applications in industries and domains seeking non-invasive, cost-effective, and sufficiently accurate head measurement solutions without the need for specialized equipment.

A non-invasive approach is used to obtain head measurements using devices like cell phones or tablets with depth sensors. Users position the back of their head against a flat surface, and images are captured that include both the head and surface. A statistical model of the head and wall extracted from the images yields sufficiently precise measurements, particularly along the front-back axis and in areas typically obscured by hair.

This approach provides a cost-effective method for acquiring head dimensions without the need for specialized equipment, reduces the complexities and potential errors associated with other photometric techniques, and offers manufacturers a tool for creating custom-fit products, enhancing user comfort and safety.

It is important for helmets and other head-worn consumer products to fit the user accurately. A typical helmet product is offered in a small number of sizes (e.g. small, medium, large) and outfitted with additional components to allow some further customization to the head. Padding throughout the interior surface and an interior circumferential band that can be ratcheted to a desired level of snugness are common. A fixed number of sizes brings additional complexity and weight for this adjustment mechanism. Furthermore, the helmet is “rounded up” to the size that fits the user, and is therefore potentially larger and heavier than needed for safety.

Additive and subtractive manufacturing processes such as 3D printing allow customization to the user's head, and potentially improve comfort, both because the native fit is more precise, and also because the airflow and weight may be improved by reducing padding, overviewed in US 20200138141 to Kwok et al. A custom process may allow additional measurements to be taken to improve the fit. This can include length, width, brow width, cheekbones, diameter around the head at the chin, age, weight, gender, hair style, hair type, personal snugness preferences, and so on. For such a custom process to create a successful fit, the dimensions and shape of the user's body must be known with sufficient accuracy.

Various challenges are posed by existing head measurement techniques. Head measurements may be taken using apparatus such as tape measures and calipers. Under laboratory conditions, the head may be measured by specialized machines.

Alternatively, the head may be measured using a digital scanning device, such as with structured light imaging or photometry comparing multiple images or video to capture a 3D point cloud. Processing of the information may include GANs (Generative Adversarial Networks, a volumetric representation such as NeRF (Neural Rendering Fields) and so on.

However, hair obstructs direct optical measurements of the head, hindering accurate readings. It is possible to have the user modify the hair, i.e. shaving, slicking back, or wearing a stretchy cap. However, such techniques are unpleasant or require first delivering to the user specialized apparatus such as a swim cap, calipers, etc.

Another problem with photometric techniques is that large objects far away may not be mathematically distinguishable from smaller objects close to the camera. That is, the absolute size is not necessarily knowable without some absolute standard in the image. In machine vision, it is common to calibrate using an object of known size; for example, a pattern printed on paper or some other objects of known size (coins, dollar bills, credit cards) could be incorporated. Correctly using such reference objects increases the chance of measurement errors for the casual consumer.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates side, front and top views of poses for collecting images for use in the method, according to some examples.

FIG. 2 illustrates computation of loss functions associated with identity and expressions, according to some examples.

FIG. 3 illustrates computation of photometric loss. according to some examples.

FIG. 4 illustrates computation of silhouette loss, according to some examples.

FIG. 5 illustrates computation of depth loss, according to some examples.

FIG. 6 illustrates computation of landmark loss. according to some examples.

FIG. 7 illustrates computation of wall distance loss, according to some examples.

FIG. 8A and FIG. 8B show a flow diagram illustrating a method of head dimension measurement and use, according to some examples.

FIG. 9 is a flowchart depicting a machine learning lifecycle, according to some examples.

FIG. 10 is a flowchart depicting a machine-learning pipeline, according to some examples.

FIG. 11 illustrates a simplified system in which a server and a client device are communicatively coupled via a network, according to some examples.

FIG. 12 illustrates a diagrammatic representation of a machine in the form of a computer system within which a set of instructions may be executed for causing the machine to perform any one or more of the methodologies discussed herein, according to some examples.

FIG. 13 is a block diagram illustrating a software architecture, which can be installed on any one or more of the devices described above, according to some examples.

### DETAILED DESCRIPTION

The phrases “in one example”, “in various examples”, “in some examples”, and the like are used repeatedly. Such phrases do not necessarily refer to the same example. The terms “comprising”, “having”, and “including” are synonymous, unless the context dictates otherwise.

Reference is now made in detail to the description of the examples as illustrated in the drawings. While examples are described in connection with the drawings and related descriptions, there is no intent to limit the scope to the examples disclosed herein. On the contrary, the intent is to cover all alternatives, modifications and equivalents. In alternate examples, additional devices, or combinations of illustrated devices, may be added to or combined, without limiting the scope to the examples disclosed herein.

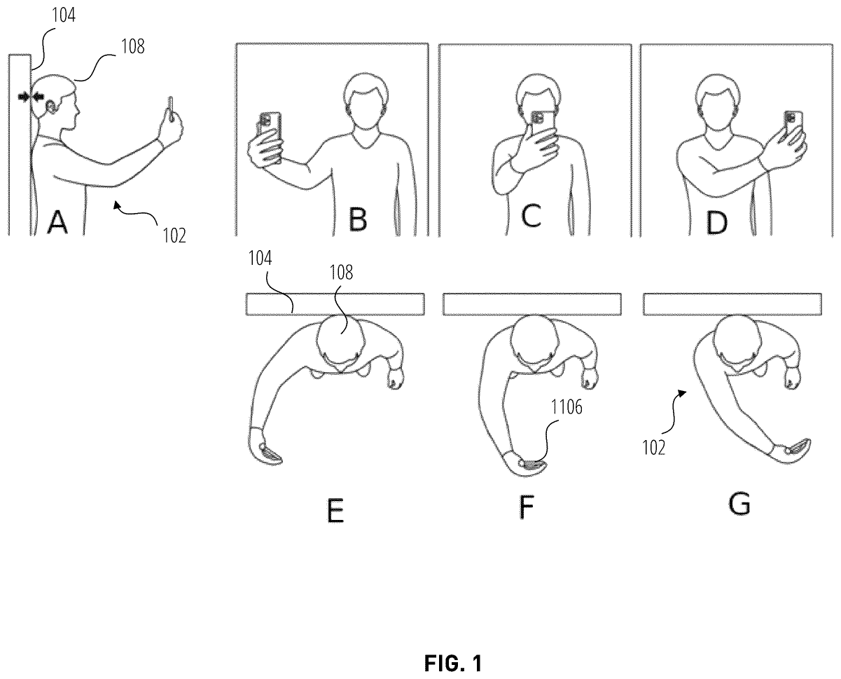

FIG. 1 illustrates side, front and top views of poses for collecting images for use in the method, according to some examples.

Not requiring additional objects to be delivered to a user speeds order fulfillment and reduces cost, and users now often own a user device 1106 with depth sensors (e.g. cell phone or tablet with structured light, lidar, or disparity imaging). The user 102 stands with the back of their head 108 against a flat surface such as a wall 104 or door, and generates one or more images including both the head 108 and wall 104 using the image and depth sensors included in the user device 1106. The key insight is that since the wall 104 is known to be flat and is measured over a large portion of the image, the wall coordinates may be estimated accurately.

The following steps are performed:
1. The user 102 positions their head against a flat surface.
2. The user device 1106 captures images.
3. The images are processed to extract depth information, segmentation and landmarks.
4. Machine learning models interpret and convert this data into head dimensions.
5. The results are presented to the user or forwarded to a manufacturing entity.

FIG. 1 illustrates views labeled A through G, of a user 102 capturing three images for processing. View A is a side view illustrating the user's head 108 against the wall. Views B, C and D are front views; Views E, F and G are corresponding top views showing the user's head 108 against the wall 104. Views B & E, C & F, and D & G show positions of the user device 1106 for each of the three images that are captured. Although three images are illustrated, any number of images, fused point clouds, and/or video may be gathered. In the illustrated example, one image is captured from a right-front viewpoint (from the perspective of the viewer), one image is captured from directly ahead, and one image is captured from a left-front viewpoint.

In some examples, the captured images are preprocessed. Preprocessing may include standard image processing techniques such as format conversion, extraction of image metadata, well-known filters (ex. sharpening, edge detection, face detection), and interpolation and/or filtering of incomplete or inaccurate depth data.

Ambient lighting conditions may also affect the quality of the captured images. For example, low lighting may result in increased pixel noise or motion blur due to shaking during long exposures. High levels of lighting, such as direct sunlight, may cause overexposure or inaccuracy when using an infrared depth sensor. In some examples, the machine learning model may detect unfavorable lighting conditions and include inputs designed to warn when such conditions may occur, or to adjust and enhance depth data processing based on the ambient lighting conditions.

Machine learning models adjust to ambient lighting conditions may use a mix of data augmentation (training with data that has been artificially modified to simulate various lighting conditions), feature engineering (training to focus on features that are invariant to lighting conditions such as edges or contours, or using color normalization), learning-based illumination correction (using neural networks or deep learning architectures), adaptive modeling based on real-time feedback about lighting conditions, domain adaptation (in which models are fine-tuned or adapted to the specific lighting conditions of the target environment), and adaptive models (in which models dynamically adjust their parameters based on real-time feedback about lighting condition.)

In some examples, the user device 1106 uses multiple measurement modalities concurrently to enhance depth measurement accuracy. Cell phones may have depth sensor(s) as well as multiple image sensors (e.g., standard and wide-angle) that take simultaneous images that are combined photometrically to produce depth and focus depth tracking. Known techniques provide multiple options or a fusion of these sources of data, including but not limited to depth maps, combined on-device or in raw images derived from multiple cameras.

The images include depth information as well as a visual image of the visible parts of the user's head and at least a portion of the wall 104. The visual and depth images are conveyed to a computing device (a remote server, or processors on the user's device) that converts the images to specific dimensions of the user's head.

### Computation and Modeling

The computing device (user device 1106 or remote computing device, for example) uses a statistical head model to fit the observed head coordinates, under the additional constraint that the hidden part of the back of the head 108 touches the plane of the wall 104. This provides confidence in the front-back axis of the head and allows improved estimation of the other areas obscured by hair, as predicted by the model.

One example of the computations performed is now described using a conventional ‘analysis by synthesis’ optimization of a sum of differentiable loss functions.

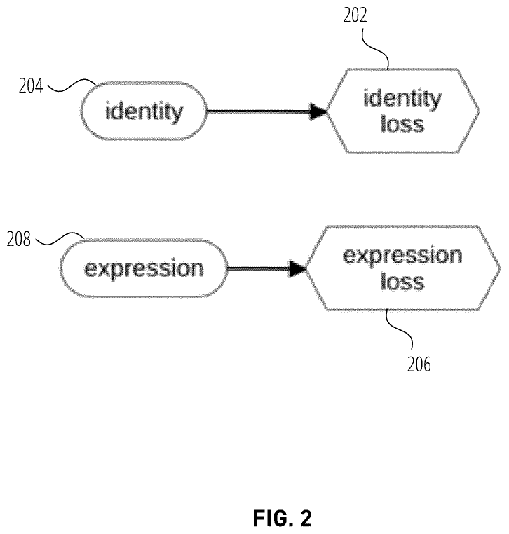

Losses. The optimizer seeks to minimize a combined sum of loss functions. FIG. 2 to FIG. 7 illustrate the computation divided into independent loss terms. Rectangular blocks are computed values, rounded blocks are parameters to be estimated, and hexagonal blocks are loss functions to optimize the parameters. Arrows describe functional dependence, such that during optimization evaluation follows the forward direction of each arrow and differentiation is performed in the other direction.

Preprocessing. The following figures and associated descriptions rely on information extracted from the images using known techniques, in particular:
1. Visual and depth images.
2. Intrinsic matrices relating the images to camera coordinates.
3. Segmentation of images into regions for background, hair, face, etc.
4. 2D coordinates within images for facial landmarks such as eyes, nose, etc.

Techniques 1 and 2 above are described in the work of Urban, Steffen, et al. “On the Issues of TrueDepth Sensor Data for Computer Vision Tasks Across Different iPad Generations.” arXiv preprint arXiv: 2201.10865 (2022), the contents of which are incorporated herein by reference as if explicitly set forth.

Techniques 3 and 4 above are described in the work of Zheng, Yinglin, et al. “General facial representation learning in a visual-linguistic manner.” Proceedings of the IEEE/CVF Conference on Computer Vision and Pattern Recognition. 2022, the contents of which are incorporated herein by reference as if explicitly set forth.

In some examples machine learning models are used to account for variability introduced by different hairstyles, thereby normalizing hair-induced deviations from the actual head shape. Using the segmented images, such machine learning models estimate attributes of the subject such as overall baldness and the presence of facial hair of the individual. These can be used to set the expected accuracy of depth data.

Machine learning models for this purpose are trained on a ground truth data set of images of people with various hair attributes, including color, style, type, length, baldness, different types of facial hair, with an associated set of known head dimensions and shapes.

Optimization, in some examples, is performed using gradient descent, which is a known concept in machine learning and mathematical optimization. It involves finding the minimum or maximum of a mathematical function by iteratively adjusting its parameters based on the gradient, which is a vector that points in the direction of the steepest increase of the function. In machine learning, this is primarily used to minimize a loss or cost function with respect to the model's parameters, making the model better at performing a specific task (e.g., classification, regression).

Common optimization-related terminology includes:

Objective Function (Loss Function): An objective function, often called the loss function or cost function, that quantifies how well the model is performing. The goal of optimization is to minimize this function.

Model Parameters: The model has a set of parameters (weights and biases) that determine its behavior. The objective is to find the best values for these parameters that minimize the loss function.

Optimization: Minimization of the loss function can occur by any known optimization algorithm, but is commonly done by a variation on gradient descent. Gradient descent works as follows:

An initial guess is used for the model parameters and the relevant loss values are determined using these initial values. The gradient of the loss function with respect to the model parameters is computed. The gradient quantifies how the loss (e.g., photometric loss, silhouette loss, depth loss, landmark loss, wall distance loss) changes as small adjustments are made to each parameter. The model parameters are updated by moving in the opposite direction of the gradient, by subtracting a fraction of the gradient from the current parameter values. The fraction is called the learning rate, and it determines the step size of each update. The process is repeated iteratively until convergence (when the loss stops decreasing or decreases very slowly) or for a predefined number of iterations.

FIG. 2 illustrates computation of loss functions associated with identity and expressions, according to some examples.

Identity loss plays an important role in tasks where a model needs to learn representations that preserve or differentiate identities, in areas like face recognition, biometric identification, or in generative tasks such as head model creation where the identity of the subject must remain consistent. The primary goal of identity loss in optimization is to ensure that the model preserves distinct and consistent identities across its predictions by minimizing the distance between representations of the same identity and maximizing the difference for different identities.

Expression loss measures the similarity between the facial expressions of a target image (real or reference) and the generated image by comparing key facial features that encode expressions, such as facial landmarks, expression vectors, or embeddings from a pre-trained expression recognition model.

The head model is capable at a minimum of deciding which of multiple candidate estimated user's head dimensions is more likely. The most conventional representation is a triangle mesh with fixed structure and vertices that are a (possibly linear) function of input parameters; this is described in the work of Li, Tianye, et al. “Learning a model of facial shape and expression from 4D scans.” ACM Trans. Graph. 36.6 (2017): 194-1, the contents of which are incorporated herein by reference as if explicitly set forth.

FIG. 2 illustrates a head model with two losses, one for the expression-neutral ‘identity’ base case and another ‘expression’ for components making up facial expressions. The identity loss function 202, operating on identity parameters 204, is applied to all images but the expression loss function 206, operating on expression parameters 208, is optionally applied to account for different facial expressions for each image. Is it common for the loss to be a sum of squares of the parameters. In some examples, these models are trained on a diverse dataset of known head dimensions and images encompassing varying ages, genders, ethnicities, weight, hair styles, and hair types, using known techniques such as modified loss expressions.

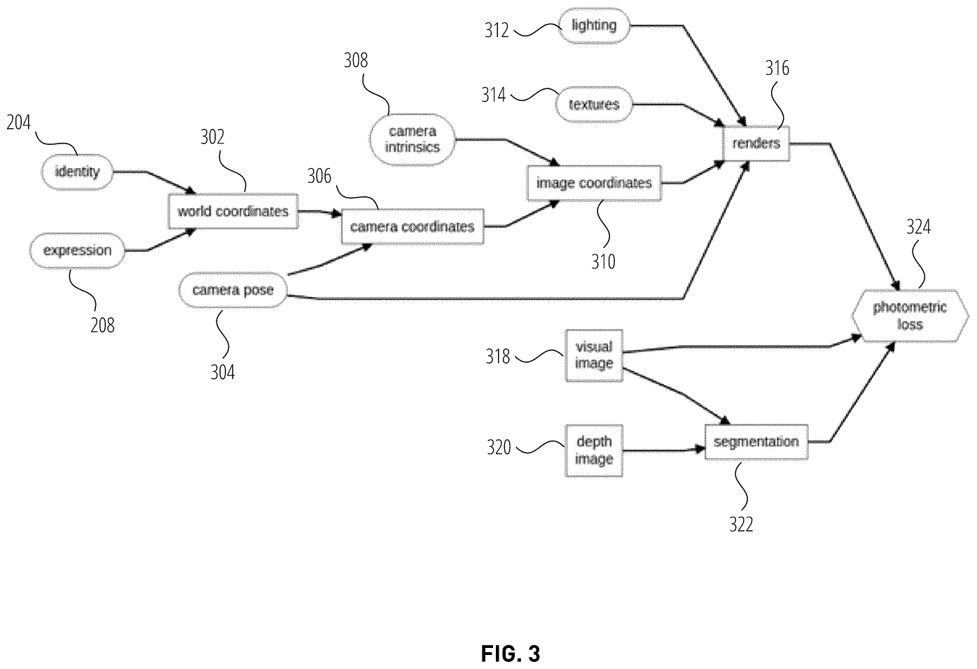

FIG. 3 illustrates computation of photometric loss, according to some examples. Photometric loss is commonly used in computer vision tasks, particularly in image reconstruction, optical flow, and depth estimation. It measures the difference in pixel intensity between two images or frames, aiming to quantify how similar or dissimilar they are in terms of brightness and appearance. The photometric loss is typically employed to ensure that the predicted output (such as an image, a frame, or a flow field) closely matches the reference or ground truth image. Photometric loss quantifies the pixel-wise difference between predicted and reference images, guiding the optimization of models to produce outputs that closely match the true image or scene.

That is, photometric loss enforces that the images represent the same coherent object. This can be done by optimizing a volumetric representation (e.g. NeRF), texture mapping a mesh (described in the works of Feng, Yao, et al. “Learning an animatable detailed 3D face model from in-the-wild images.” ACM Transactions on Graphics (ToG) 40.4 (2021): 1-13 and Zielonka, Wojciech, Timo Bolkart, and Justus Thies. “Towards metrical reconstruction of human faces.” European Conference on Computer Vision. Cham: Springer Nature Switzerland, 2022, the contents of which are incorporated herein by reference as if explicitly set forth.

In all cases it is necessary to relate the image pixels to the head coordinates as shown in FIG. 3:

Optimized identity parameters 204 and expression parameters 208 are combined to produce world coordinates 302 of the features in the captured image.

A camera pose 304 (position and orientation) determined by position components 1238 and motion components 1234 in the user device 1106 is used to convert the world coordinates 302 of the features in the captured image to camera coordinates 306.

Camera intrinsic parameters 308, such as focal length, principal point, skew coefficient(s), aspect ratio, and radial and tangential distortion coefficients, are used to convert the camera coordinates 306 of the features in the captured image to 2D image coordinates 310.

Lighting parameters 312 and texture parameters 314 are used to render the image coordinates to a synthetic visual image. The photometric loss 324 is then determined by comparing the synthetic image to compared to the captured image, comprising the visual image 318 and the depth image 320. Trusted areas such as the face are weighted more in the comparison, as determined by the image segmentation 322.

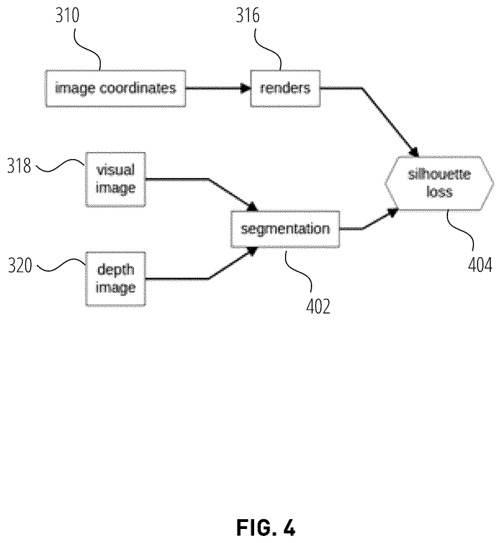

FIG. 4 illustrates computation of silhouette loss, according to some examples. Silhouette loss is commonly used in computer vision tasks related to 3D reconstruction, shape modeling, or object segmentation, where the goal is to ensure that a predicted 3D shape or segmentation mask aligns with the ground truth silhouette (or mask) of an object. This loss is especially important when dealing with tasks that involve predicting 3D objects from 2D views or ensuring that the rendered shape matches the observed silhouette.

Silhouette loss measures the difference between predicted and ground truth binary masks or silhouettes, and it can be computed using L1/L2 norms, binary cross-entropy, or overlap-based metrics like IoU or Dice loss. It is widely used to ensure accurate shape predictions in tasks like segmentation and 3D reconstruction.

As before, the image coordinates 310 are determined and a render 316 generated as described above with reference to FIG. 3, if they have not already been determined/generated in another loss function determination.

Image segmentation 402 is performed on the visual image 318 and depth image 320 to determine which pixels are definitely part of the wall, which are of the user's head, and which pixels are uncertain. Silhouette loss 404 is then performed on the image segments determined in segmentation 402 against corresponding segments in the render 316. The silhouette loss 404 penalizes rendering the head where the wall must be, or vice versa. The image segmentation may be used to select different policies for subsets of the image.

The silhouette loss 404 loss is greater when the set of pixels for the modeled head disagrees with the set of pixels comprising the head in the visual image. This may be considered for each pixel independently, considering 2D distances in the image, or by 3D ray-mesh distances using a subset of points.

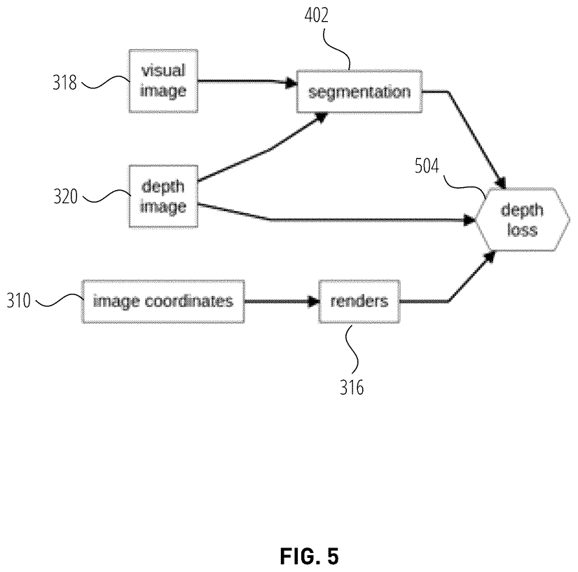

FIG. 5 illustrates computation of depth loss, according to some examples. In 3D scene reconstruction, depth loss plays a key role in ensuring that the predicted 3D structure of a scene aligns with the real-world depth information captured by sensors or calculated from multiple images. The process of reconstructing 3D scenes typically involves predicting depth for each point or pixel in a 2D image and using that depth information to build a 3D model. Depth loss is computed by comparing the predicted depth values with ground truth depth values or by ensuring consistency between multiple views of the scene.

As before, the image coordinates 310 are determined and a render 316 generated as described above with reference to FIG. 3, if they have not already been determined/generated in another loss function determination.

Image segmentation 402 is performed on the visual image 318 and depth image 320 to determine which pixels are definitely part of the wall, which are of the user's head, and which pixels are uncertain.

Depth loss 504 is then performed by comparing the synthetic rendered depth to the actual sensor depth image in areas where the segmentation indicates depth should be trusted. Depth may be considered for each pixel independently or by 3D point-mesh distances using a subset of points. The image segmentation may be used to select different policies for subsets of the image.

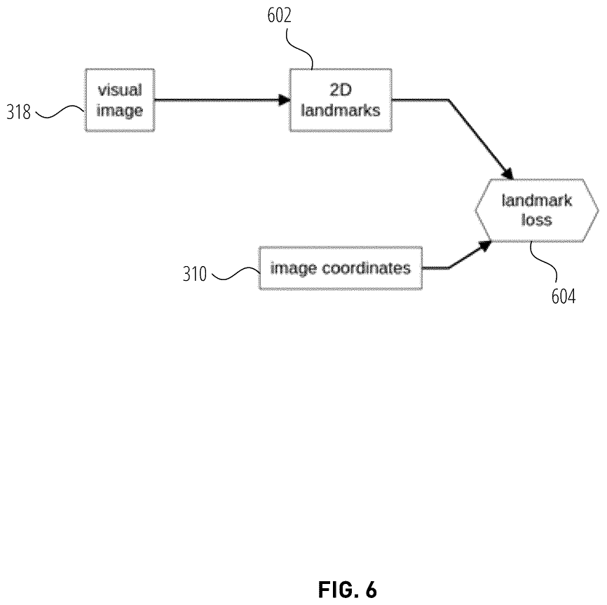

FIG. 6 illustrates computation of landmark loss, according to some examples. The computation of landmark loss is commonly used in image processing tasks that involve detecting or aligning keypoints or landmarks on objects, particularly in facial recognition, human pose estimation, and object alignment tasks. The goal of landmark loss is to measure the difference between the predicted positions of specific landmarks (such as facial points, joints, or object corners) and the ground truth positions. It is computed using pixel-wise differences (L1 or L2 norms), heatmap-based methods, and can be normalized or weighted for more robustness. Additional terms like smoothness and structural regularization can also be incorporated to maintain consistent relative landmark positions, ensuring accurate detection and alignment in complex scenarios.

As before, the image coordinates 310 are determined as described above with reference to FIG. 3, if they have not already been determined in another loss function determination. 2D landmark extraction 602 is performed on the visual image 318. Landmark loss 604 is then determined by comparing landmark locations (corners of the eyes, mouth, etc.) in the visual image 318 to the corresponding 2D landmarks in the synthetic image.

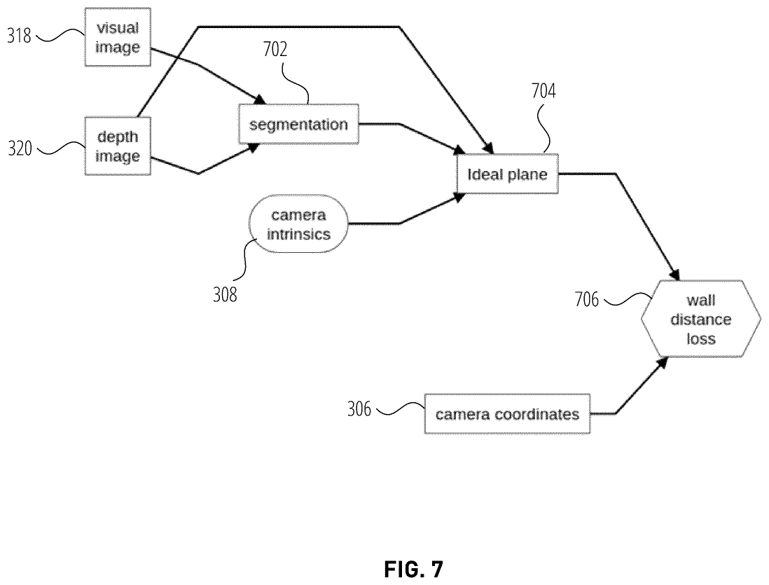

FIG. 7 illustrates computation of wall distance loss, according to some examples. Wall distance loss is a specialized type of loss used in fitting a plane to a depth image, particularly in applications like indoor scene understanding, where walls (or planar surfaces) are key features. The goal is to measure how well a predicted plane fits the actual wall or surface by minimizing the distance between the depth points in the image and the corresponding points on the plane.

In this context, the wall distance loss ensures that the points in the depth image that belong to a wall or planar surface, or are adjacent to the wall or planar surface, such as the back of the user's head 108, lie close to the predicted plane. Additionally, positioning the user's head against the planar surface during image capture provides a plane of points that vary consistently and predictability in three dimensions, which provides a reference surface, points on which that can be used to calibrate and enhance the accuracy of depth measurements by comparing the measured depth measurements on the plane to depth measurements determined from the predicted plane.

As before, the image camera coordinates 306 are determined as described above with reference to FIG. 3, if they have not already been determined in another loss function determination.

Image segmentation 702 is performed on the visual image 318 and depth image 320 to determine which pixels are definitely part of the wall, which are of the user's head, and which pixels are uncertain. Camera intrinsic parameters 308 are then used on the pixels that have been determined to be part of the wall to determine an ideal plane 704. Wall distance loss 706 is then performed by comparing the ideal plane 704 to the corresponding plane in the synthetic image.

An ideal plane can be constructed by fitting the general plane equation to the depth image using a technique such as RANSAC, described in the work of Schnabel, Ruwen, Roland Wahl, and Reinhard Klein. “Efficient RANSAC for point-cloud shape detection.” Computer graphics forum. Vol. 26. No. 2. Oxford, UK: Blackwell Publishing Ltd, 2007, the contents of which are incorporated herein by reference as if explicitly set forth. In this example, the wall distance loss 706 determines the head coordinate(s) closest to this ideal wall and penalizes when the distance from the head to the closest point on the ideal plane is greater than zero.

After optimization of all the loss functions for each of the three captured images compared to their corresponding synthetic image, head dimensions can then be determined from the optimized model of the head. The resulting head dimensions may be rendered immediately to the user by compositing it onto their images for approval, by rendering the entire head model, emailing it for later perusal, transmitting the model digitally for manufacturing, etc.

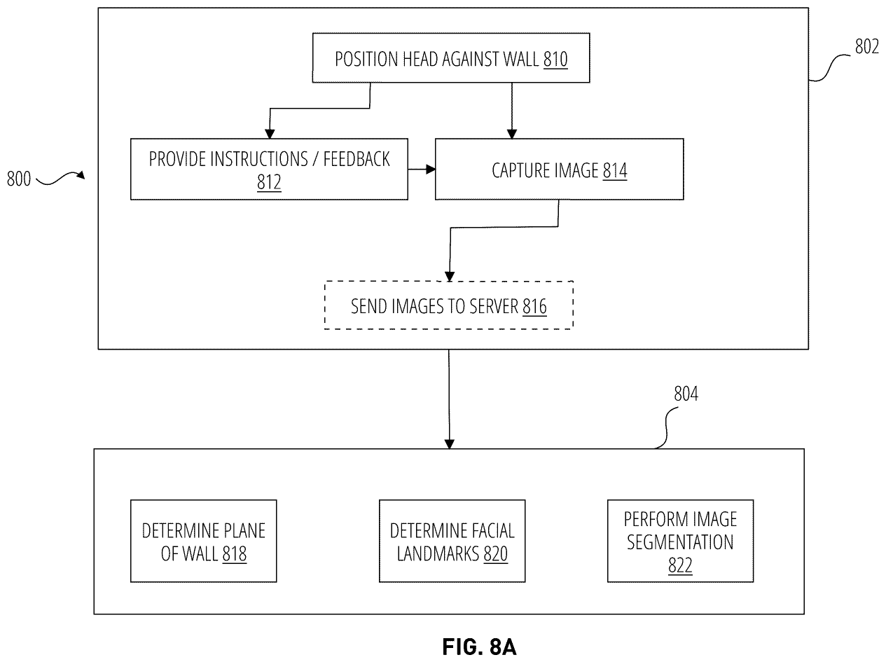

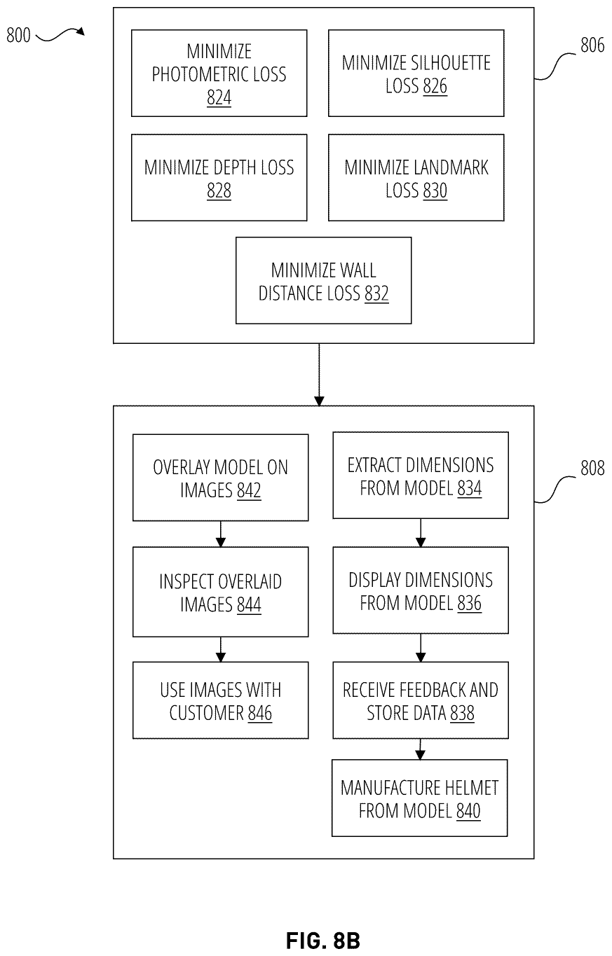

FIG. 8A and FIG. 8B show a flow diagram illustrating a method 800 of head dimension measurement and use, according to some examples. Although the flowchart depicts a particular sequence of operations, the sequence may be altered without departing from the scope of the present disclosure. For example, some of the operations depicted may be performed in parallel or in a different sequence that does not materially affect the function of the method 800. In other examples, different components of an example device or system that implements the flowchart may perform functions at substantially the same time or in a specific sequence.

The method 800 comprises four steps. Step one 802 is the obtaining or retrieval of three images. Step two 804 is the application of established techniques to extract additional information from each image. Step three 806 is the determination of head rotation, translation, and shape using the output from step one 802 and step two 804. Step four 808 is the use of the information determined in the prior steps for communication with the customer, marketing, and manufacturing.

Prior to commencement of the method 800, the user has obtained or is in possession of a user device 1106 to take their picture, and obtains instructions and software to take images, possibly including downloading executable code to their user device 1106.

The method 800 starts with the user initiating the head measurement procedure in an application on the user device 1106. Following the provision of any initial instructions to the user, the method 800 proceeds to operation 810 with the user following instructions to position their head against a wall, and three or more images are captured by their user device 1106 as described above with reference to FIG. 1 in operation 814. In so doing, the user device 1106 captures data from various sensors on the user device 1106, including a visual camera and a depth sensor such as Apple's TrueDepth structured light system, LiDAR and so forth.

In parallel with the image capture occurring in operation 814, in some examples instructions and feedback are provided to the user in operation 812. For example, the display of the user device 1106 may show images captured by the front-facing camera to the user. The pose of the head as captured by the front facing camera is determined, and used in a feedback loop to actively guide the user in positioning and moving the camera so that appropriate or desired head poses are obtained during image capture.

For example, indicators such as arrows showing the direction in which a camera should be moved may be shown on the display relative to their head, or a synthetic model may be generated and rendered on the display, with which the user is to align their head. In some examples, the synthetic model of the head is displayed at the location of the user's head in the image, using augmented reality techniques.

In some examples, the visual instructions are provided as a trial run, so that the user can rehearse the capture procedure in advance of the actual capture. This has the advantage that the user is familiar with the procedure, before performing the actual image capture with the rear side of the user device 1106 pointing towards them. The rear side of the device may include multiple cameras and sensors, whereas the front side may only include a single camera. The display screen of the user device 1106 will thus not be visible to the user 102 during the image capture process. In some examples, verbal feedback is generated during the actual image capture, to provide movement and positioning instructions, based on the user device 1106 comparing an actual head pose with a desired head pose.

The images may be communicated to a server 1104 for archiving and/or processing, in operation 816.

In some examples, the output from step one 802 includes:
a. A visual image: pixels representing the visual image;
b. A depth image: values representing the distance between the camera sensor and scene (head or wall) along the optical axis;
c. An intrinsic matrix that specifies field of view or focal length, allowing pixel values to be associated with light reaching the camera from specific directions; and
d. Any available estimate of camera distortion due to imprecise optics, quantization, compression, etc.

The method 800 then continues to step two 804, where the user device 1106 (or server 1104) applies established techniques to extract additional relevant information from each image independently, as follows. In operation 818 the user device 1106 determines the plane of the wall as a description of an ideal mathematical ideal plane relative to the camera position. In operation 820, the user device 1106 determines a list of facial landmarks locations in the visual images, such as the corners of eyes, mouth, etc.) In operation 822 the user device 1106 performs image segmentation to discriminate each pixel into face, hair, background, etc.

The outputs from step two 804 are then used in step three 806 (see FIG. 8B), in which the user device 1106 then applies one or more iterative algorithms to the data captured or determined in step one 802 and step two 804 to determine head rotation, translation, and head shape. In some examples, a loss function is defined that represents whether the observed data would be more or less likely to be seen for particular settings of parameters that define head poses and head shape.

Following the conventional numerical approach, unknown values are given arbitrary guesses, the loss function is computed (‘forward pass’); the loss function's gradient is computed (‘backward pass’), updated parameters are computed using the gradient and/or gradient history, and these operations are re repeated while improvement in the loss function is seen.

More specifically, using an initial model of the shape and size of the user's head and the captured or determined data, the user device 1106 minimizes photometric loss 324 in operation 824 as described above with reference to FIG. 3, minimizes silhouette loss 404 in operation 826 as described above with reference to FIG. 4, minimizes depth loss 504 in operation 828 as described above with reference to FIG. 5, minimizes landmark loss 604 in operation 830 as described above with reference to FIG. 6, and minimizes wall distance loss 706 in operation 832 as described above with reference to FIG. 7. In particular, the model of the user's head is constrained by the fact that it cannot extend into the determined plane at the point of intersection of the wall. These operations refine an initial model of the user's head so that it reflects the size and shape of the user's head and the poses in the captured images. Step three 806 is solved simultaneously for all of the captured images, by minimizing a loss function that includes terms for all of the various constraints.

In some examples, a resolution parameter can be specified for the extracted depth-related attributes and/or the determined head measurements. The resolution parameter(s) can be used to terminate the optimization process, when, for example, subsequent iterations are within the limits specified for the depth parameter and/or the determined head measurements. This allows for scalability in processing based on the required precision of head dimensions. The resolution parameter can, for example, be based on, for example, a fraction of an increment in helmet sizes.

The model of the user's head can now be used for communication with the customer, for marketing, and for manufacturing in step four 808.

In some examples, the model of the user's head and the pose of each captured image are used to project a 2D projection of the shape of the user's head, as represented by the model, on the representation of the user's actual head in each captured image, in operation 842. The resulting images can be provided to the user for user review and approval and/or to manufacturing personnel for manufacturing review and approval in operation 844. The images can then be used by or for the user, for example for social media posts, for marketing purposes such as when providing product recommendations, and so forth.

The user device 1106 (or server 1104) extracts relevant dimensions from the model, such as the back to front length of the user's head, the width of the user's head, and so on, at appropriate known locations on the model, in operation 834.

The determined dimensions are then displayed, in some examples, to the user for user approval or information and/or to manufacturing personnel for manufacturing approval or information in operation 836. This display may include a comparison of the user's measurements to other user's measurements, or to known standard or typical measurements used for manufacturing of helmets for a corresponding head size. Displaying the overlay and the determined measurements in this way provides a marketing benefit, by illustrating to the user the customization that will be applied.

Additionally, in operation 838, the user can add measurements and provide input on the perceived accuracy of the acquired dimensions, allowing continuous improvement of the machine learning models. For example, the user may be queried for their head circumference taken with a measuring tape, input how well other standard helmets they own have fitted, or enter a preference for hairstyle or head covering under the helmet to be compensated for. This data is stored and used for validation, refinement or retraining of the machine learning model(s) as described below.

The final data acquired head dimensions are also stored in a user profile, enabling subsequent retrievals for use with other personalized products or applications. In some examples, a cloud-based system is provided where processed head dimensions can be accessed and retrieved from a server by authorized entities or applications, for example related fitness applications such as Strava or Training Peaks, and related shopping applications such as Amazon, that the user has linked with the application that performed the head measurements. Additionally, in such cases, the shared head dimensions from the user's profile on the particular application can be used directly, to automatically provide size recommendations for head-worn or head-related products such as helmets, spectacles, hats, beanies, and so forth.

In operation 840, the user's head shape and/or dimensions are used to manufacture a custom-fit helmet or other head-worn or head-related products, in some examples.

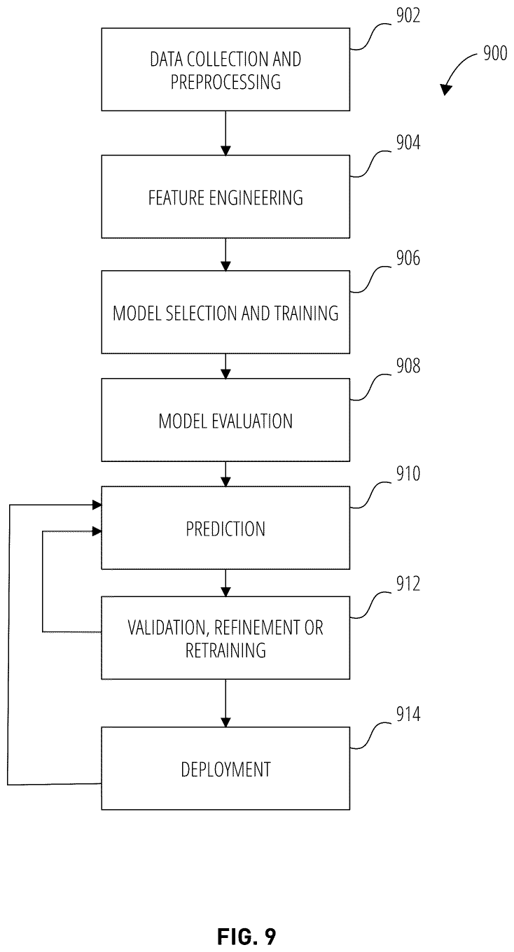

FIG. 9 is a flowchart depicting a machine learning lifecycle 900, according to some examples. The lifecycle 900 includes the following phases:

Data collection and preprocessing 902: This phase may include acquiring and cleaning data to ensure that it is suitable for use in the machine learning model. This phase may also include removing duplicates, handling missing values, and converting data into a suitable format.

Feature engineering 904: This phase may include selecting and transforming the training data 1006 to create features that are useful for predicting the target variable. Feature engineering may include (1) receiving features 1008 (e.g., as structured or labeled data in supervised learning) and/or (2) identifying features 1008 (e.g., unstructured or unlabeled data for unsupervised learning) in training data 1006.

Model selection and training 906: This phase may include selecting an appropriate machine learning model and training it on the preprocessed data. This phase may further involve splitting the data into training and testing sets, using cross-validation to evaluate the model, and tuning hyperparameters to improve performance.

Model evaluation 908: This phase may include evaluating the performance of a trained model (e.g., the trained machine-learning program 1002) on a separate testing dataset. This phase can help determine if the model is overfitting or underfitting and determine whether the model is suitable for deployment.

Prediction 910: This phase involves using a trained model (e.g., trained machine-learning program 1002) to generate predictions on new, unseen data.

Validation, refinement or retraining 912: This phase may include updating a model based on feedback generated from the prediction phase, such as new data or user feedback.

Deployment 914: This phase may include integrating the trained model (e.g., the trained machine-learning program 1002) into a more extensive system or application, such as a web service, mobile app, or IoT device. This phase can involve setting up APIs, building a user interface, and ensuring that the model is scalable and can handle large volumes of data.

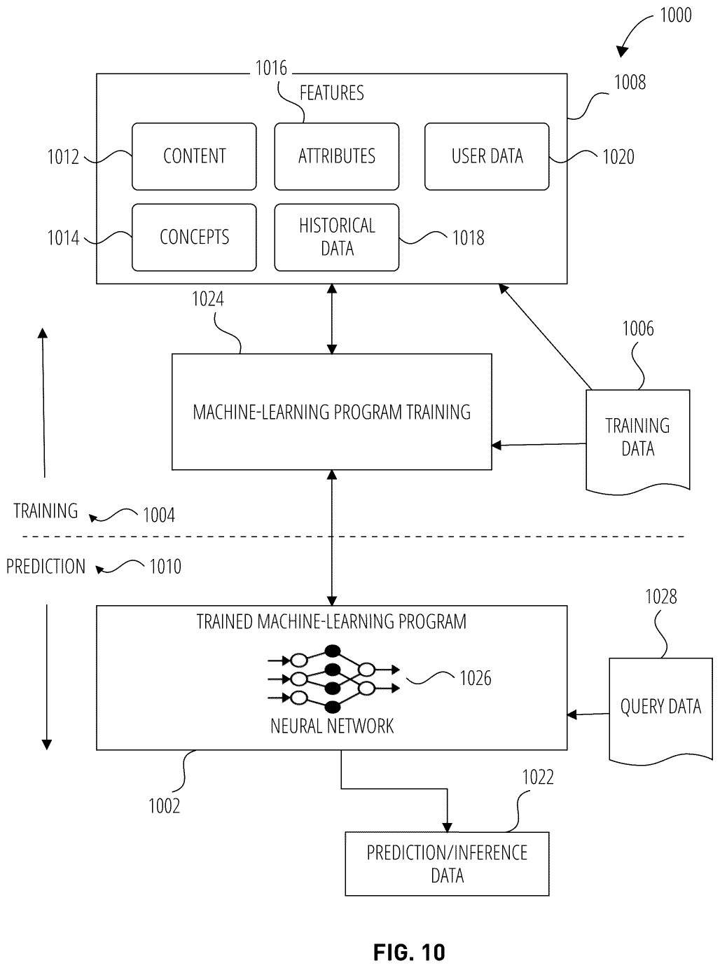

FIG. 10 is a flowchart depicting a machine-learning pipeline 1000, according to some examples. The machine-learning pipeline 1000 may be used to generate a trained model, for example the trained machine-learning program 1002 of FIG. 10, to perform operations associated with searches and query responses.

Broadly, machine learning may involve using computer models to automatically learn patterns and relationships in data, potentially without the need for explicit programming. Machine learning models can be divided into three main categories: supervised learning, unsupervised learning, and reinforcement learning.
Supervised learning involves training a model using labeled data to predict an output for new, unseen inputs. Examples of supervised learning models include linear regression, decision trees, and neural networks.
Unsupervised learning involves training a model on unlabeled data to find hidden patterns and relationships in the data. Examples of unsupervised learning models include clustering, principal component analysis, and generative models like autoencoders.
Reinforcement learning involves training a model to make decisions in a dynamic environment by receiving feedback in the form of rewards or penalties. Examples of reinforcement learning models include Q-learning and policy gradient methods.

Examples of specific machine learning models that may be deployed, according to some examples, include logistic regression, which is a type of supervised learning model used for binary classification tasks. Logistic regression models the probability of a binary response variable based on one or more predictor variables. Another example type of machine learning model is Naïve Bayes, which is another supervised learning model used for classification tasks. Naïve Bayes is based on Bayes' theorem and assumes that the predictor variables are independent of each other. Random Forest is another type of supervised learning model used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning model used for recommender systems and other tasks. Matrix factorization decomposes a matrix into two or more matrices to uncover hidden patterns or relationships in the data. Support Vector Machines (SVM) are a type of supervised learning model used for classification, regression, and other tasks. SVM finds a hyperplane that separates the different classes in the data. Other types of machine learning models include decision trees, k-nearest neighbors, clustering models, and deep learning models such as convolutional neural networks (CNN), recurrent neural networks (RNN), and transformer models. The choice of model depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning models are discussed herein, the principles discussed herein can be applied to other machine learning models as well. Deep learning models such as convolutional neural networks, recurrent neural networks, and transformers, as well as more traditional machine learning models like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression models aim at quantifying some items (for example, by providing a value that is a real number).

Generating a trained machine-learning program 1002 may include multiple phases that form part of the machine-learning pipeline 1000, including the training phases 1004 described above and illustrated in FIG. 9.

FIG. 10 illustrates further details of two example phases, namely a training phase 1004 (e.g., part of the model selection and trainings 906) and a prediction phase 1010 (part of prediction 910). Prior to the training phase 1004, feature engineering 904 is used to identify features 1008. This may include identifying informative, discriminating, and independent features for effectively operating the trained machine-learning program 1002 in pattern recognition, classification, and regression. In some examples, the training data 1006 includes labeled data, known for pre-identified features 1008 and one or more outcomes. Each of the features 1008 may be a variable or attribute, such as an individual measurable property of a process, article, system, or phenomenon represented by a data set (e.g., the training data 1006). Features 1008 may also be of different types, such as numeric features, strings, and graphs, and may include one or more of content 1012, concepts 1014, attributes 1016, historical data 1018, and/or user data 1020, merely for example.

In training phase 1004, the machine-learning pipeline 1000 uses the training data 1006 to find correlations among the features 1008 that affect a predicted outcome or prediction/inference data 1022.

With the training data 1006 and the identified features 1008, the trained machine-learning program 1002 is trained during the training phase 1004 during machine-learning program training 1024. The machine-learning program training 1024 appraises values of the features 1008 as they correlate to the training data 1006. The result of the training is the trained machine-learning program 1002 (e.g., a trained or learned model).

Further, the training phase 1004 may involve machine learning, in which the training data 1006 is structured (e.g., labeled during preprocessing operations). The trained machine-learning program 1002 implements a neural network 1026 capable of performing, for example, classification and clustering operations. In other examples, the training phase 1004 may involve deep learning, in which the training data 1006 is unstructured, and the trained machine-learning program 1002 implements a deep neural network 1026 that can perform both feature extraction and classification/clustering operations.

In some examples, a neural network 1026 may be generated during the training phase 1004, and implemented within the trained machine-learning program 1002. The neural network 1026 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 1026 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning model to optimize the performance of the network. Different types of neural networks may use different activation functions and learning models, affecting their performance on different tasks. The layered organization of neurons and the use of activation functions and weights enable neural networks to model complex relationships between inputs and outputs, and to generalize to new inputs that were not seen during training.

In some examples, the neural network 1026 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1004, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 1010, the trained machine-learning program 1002 uses the features 1008 for analyzing query data 1028 to generate inferences, outcomes, or predictions, as examples of a prediction/inference data 1022. For example, during prediction phase 1010, the trained machine-learning program 1002 generates an output. Query data 1028 is provided as an input to the trained machine-learning program 1002, and the trained machine-learning program 1002 generates the prediction/inference data 1022 as output, responsive to receipt of the query data 1028.

In some examples, the trained machine-learning program 1002 may be a generative AI model. Generative AI is a term that may refer to any type of artificial intelligence that can create new content from training data 1006. For example, generative AI can produce text, images, video, audio, code, or synthetic data similar to the original data but not identical.

Some of the techniques that may be used in generative AI are:
Convolutional Neural Networks (CNNs): CNNs may be used for image recognition and computer vision tasks. CNNs may, for example, be designed to extract features from images by using filters or kernels that scan the input image and highlight important patterns.
Recurrent Neural Networks (RNNs): RNNs may be used for processing sequential data, such as speech, text, and time series data, for example. RNNs employ feedback loops that allow them to capture temporal dependencies and remember past inputs.
Generative adversarial networks (GANs): GNNs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.

In generative AI examples, the output prediction/inference data 1022 include predictions, translations, summaries or media content.

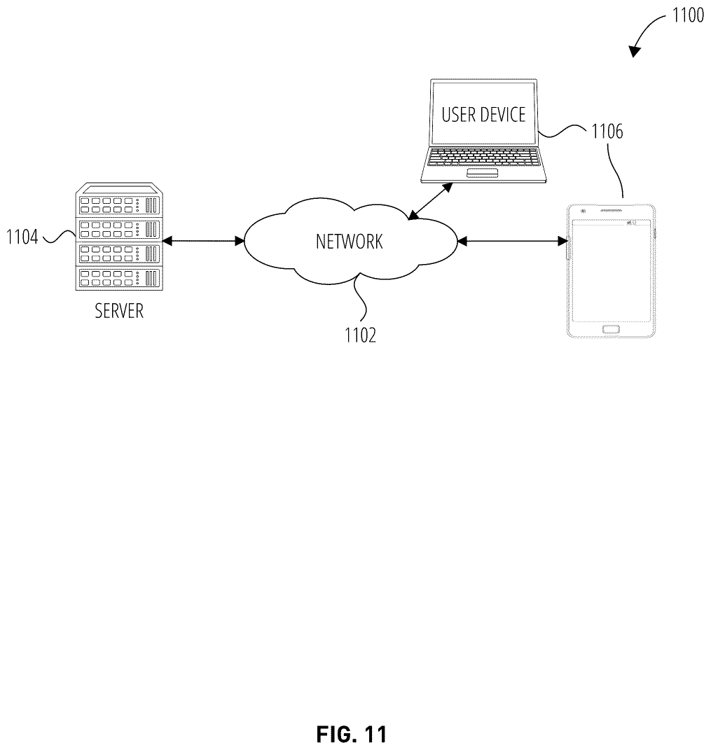

FIG. 11 illustrates a system 1100 in which a server 1104 and a user device 1106 are connected to a network 1102.

In various examples, the network 1102 may include the Internet, a local area network (“LAN”), a wide area network (“WAN”), and/or other data network. In addition to traditional data-networking protocols, in some examples, data may be communicated according to protocols and/or standards including near field communication (“NFC”), Bluetooth, power-line communication (“PLC”), and the like. In some examples, the network 1102 may also include a voice network that conveys not only voice communications, but also non-voice data such as Short Message Service (“SMS”) messages, as well as data communicated via various cellular data communication protocols, and the like.

In various examples, the user device 1106 may include desktop PCs, mobile phones, laptops, tablets, wearable computers, or other computing devices that are capable of connecting to the network 1102 and communicating with the server 1104, such as described herein.

In various examples, additional infrastructure (e.g., short message service centers, cell sites, routers, gateways, firewalls, and the like), as well as additional devices may be present. Further, in some examples, the functions described as being provided by some or all of the server 1104 and the user device 1106 may be implemented via various combinations of physical and/or logical devices. However, it is not necessary to show such infrastructure and implementation details in FIG. 8 in order to describe an illustrative example.

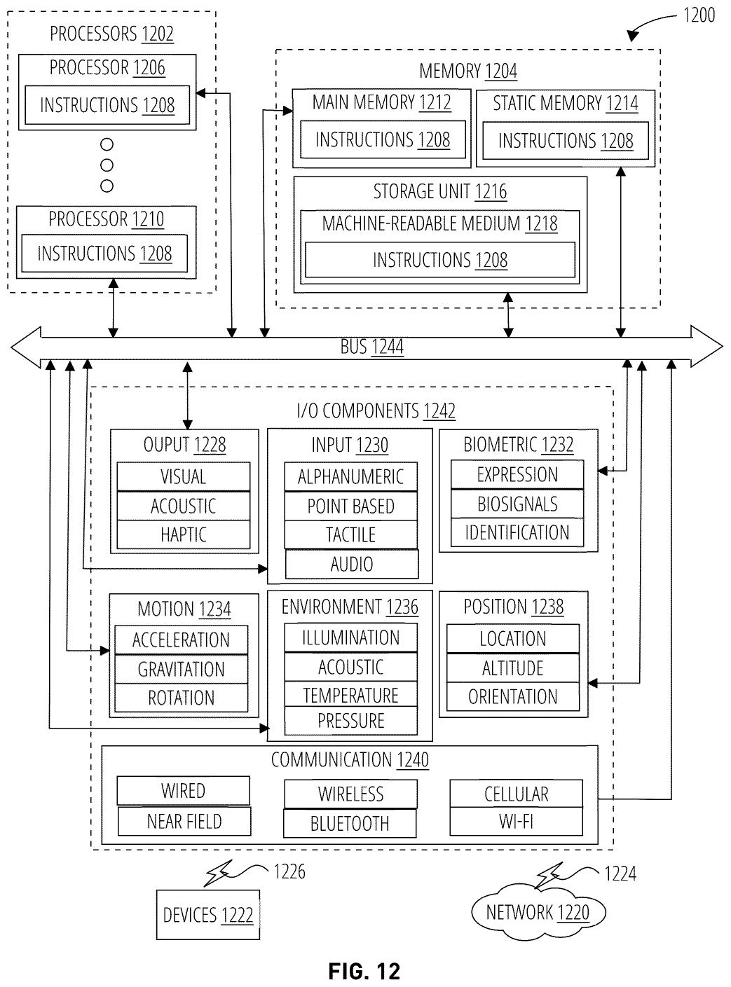

FIG. 12 illustrates a diagrammatic representation of a machine 1200 in the form of a computer system within which a set of instructions may be executed for causing the machine to perform any one or more of the methodologies discussed herein, according to an example. Specifically, FIG. 12 shows a diagrammatic representation of the machine 1200 in the example form of a computer system, within which instructions 1208 (e.g., software, a program, an application, an applet, an app, or other executable code) for causing the machine 1200 to perform any one or more of the methodologies discussed herein may be executed. For example the instructions 1208 may cause the machine 1200 to execute the operations of FIG. 8. The instructions 1208 transform the general, non-programmed machine 1200 into a particular machine 1200 programmed to carry out the described and illustrated functions in the manner described. In alternative examples, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1208, sequentially or otherwise, that specify actions to be taken by the machine 1200. Further, while only a single machine 1200 is illustrated, the term “machine” shall also be taken to include a collection of machines 1200 that individually or jointly execute the instructions 1208 to perform any one or more of the methodologies discussed herein.

The machine 1200 may include processors 1202, memory 1204, and I/O components 1242, which may be configured to communicate with each other such as via a bus 1244. In an example, the processors 1202 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1206 and a processor 1210 that may execute the instructions 1208. The term “processor” is intended to include multi-core processors that may comprise two or more independent processors (sometimes referred to as “cores”) that may execute instructions contemporaneously. Although FIG. 12 shows multiple processors 1202, the machine 1200 may include a single processor with a single core, a single processor with multiple cores (e.g., a multi-core processor), multiple processors with a single core, multiple processors with multiples cores, or any combination thereof.

The memory 1204 may include a main memory 1212, a static memory 1214, and a storage unit 1216, both accessible to the processors 1202 such as via the bus 1244. The main memory 1204, the static memory 1214, and storage unit 1216 store the instructions 1208 embodying any one or more of the methodologies or functions described herein. The instructions 1208 may also reside, completely or partially, within the main memory 1212, within the static memory 1214, within machine-readable medium 1218 within the storage unit 1216, within at least one of the processors 1202 (e.g., within the processor's cache memory), or any suitable combination thereof, during execution thereof by the machine 1200.

The I/O components 1242 may include a wide variety of components to receive input, provide output, produce output, transmit information, exchange information, capture measurements, and so on. The specific I/O components 1242 that are included in a particular machine will depend on the type of machine. For example, portable machines such as mobile phones will likely include a touch input device or other such input mechanisms, while a headless server machine will likely not include such a touch input device. It will be appreciated that the I/O components 1242 may include many other components that are not shown in FIG. 12. The I/O components 1242 are grouped according to functionality merely for simplifying the following discussion and the grouping is in no way limiting. In various examples, the I/O components 1242 may include output components 1228 and input components 1230. The output components 1228 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1230 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 1242 may include biometric components 1232, motion components 1234, environmental components 1236, or position components 1238, among a wide array of other components. For example, the biometric components 1232 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1234 may include acceleration sensor components (e.g., accelerometer), gravitation sensor components, rotation sensor components (e.g., gyroscope), and so forth. The environmental components 1236 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1238 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1242 may include communication components 1240 operable to couple the machine 1200 to a network 1220 or devices 1222 via a coupling 1224 and a coupling 1226, respectively. For example, the communication components 1240 may include a network interface component or another suitable device to interface with the network 1220. In further examples, the communication components 1240 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1222 may be another machine or any of a wide variety of peripheral devices (e.g., a peripheral device coupled via a USB).

Moreover, the communication components 1240 may detect identifiers or include components operable to detect identifiers. For example, the communication components 1240 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1240, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., memory 1204, main memory 1212, static memory 1214, and/or memory of the processors 1202) and/or storage unit 1216 may store one or more sets of instructions and data structures (e.g., software) embodying or utilized by any one or more of the methodologies or functions described herein. These instructions (e.g., the instructions 1208), when executed by processors 1202, cause various operations to implement the disclosed examples.

As used herein, the terms “machine-storage medium,” “device-storage medium,” “computer-storage medium” mean the same thing and may be used interchangeably in this disclosure. The terms refer to a single or multiple non-transitory storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various examples, one or more portions of the network 1220 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1220 or a portion of the network 1220 may include a wireless or cellular network, and the coupling 1224 may be a Code Division Multiple Access (CDMA) connection, a Global System for Mobile communications (GSM) connection, or another type of cellular or wireless coupling. In this example, the coupling 1224 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1208 may be transmitted or received over the network 1220 using a transmission medium via a network interface device (e.g., a network interface component included in the communication components 1240) and utilizing any one of a number of well-known transfer protocols (e.g., hypertext transfer protocol (HTTP)). Similarly, the instructions 1208 may be transmitted or received using a transmission medium via the coupling 1226 (e.g., a peer-to-peer coupling) to the devices 1222. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1208 for execution by the machine 1200, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

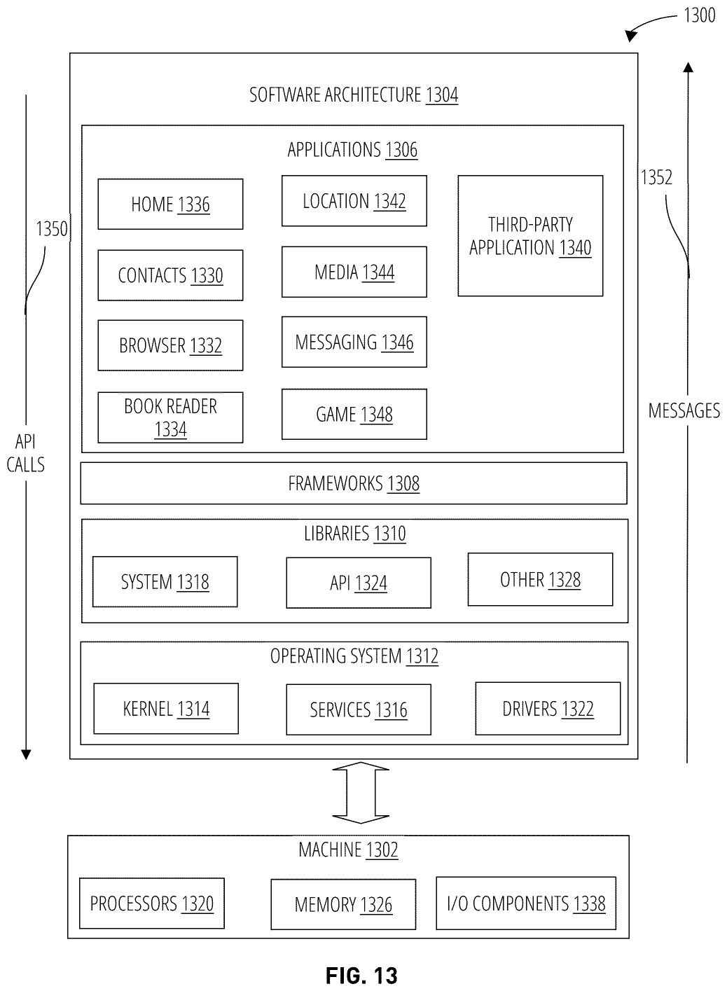

FIG. 13 is a block diagram 1300 illustrating a software architecture 1304, which can be installed on any one or more of the devices described above. FIG. 13 is merely a non-limiting example of a software architecture, and it will be appreciated that many other architectures can be implemented to facilitate the functionality described herein. In various examples, the Software architecture 1304 is implemented by hardware such as a machine 1302 of FIG. 2 that includes processors 1320, memory 1326, and I/O components 1338. In this example architecture, the software can be conceptualized as a stack of layers where each layer may provide a particular functionality. For example, the software architecture 1304 includes layers such as an operating system 1312, libraries 1310, frameworks 1308, and applications 1306. Operationally, the applications 1306 invoke application programming interface (API) calls 112 through the software stack and receive messages 1352 in response to the API calls 1350, consistent with some examples.

In various implementations, the operating system 1312 manages hardware resources and provides common services. The operating system 1312 includes, for example, a kernel 1314, services 1316, and drivers 1322. The kernel 1314 acts as an abstraction layer between the hardware and the other software layers, consistent with some examples. For example, the kernel 1314 provides memory management, processor management (e.g., scheduling), component management, networking, and security settings, among other functionality. The services 1316 can provide other common services for the other software layers. The drivers 1322 are responsible for controlling or interfacing with the underlying hardware, according to some examples. For instance, the drivers 1322 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some examples, the libraries 1310 provide a low-level common infrastructure utilized by the applications 1306. The libraries 1310 can include system libraries 1318 (e.g., C standard library) that can provide functions such as memory allocation functions, string manipulation functions, mathematic functions, and the like. In addition, the libraries 1310 can include API libraries 1324 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1310 can also include a wide variety of other libraries 1328 to provide many other APIs to the applications 1306.

The frameworks 1308 provide a high-level common infrastructure that can be utilized by the applications 1306, according to some examples. For example, the frameworks 1308 provide various graphic user interface (GUI) functions, high-level resource management, high-level location services, and so forth. The frameworks 1308 can provide a broad spectrum of other APIs that can be utilized by the applications 1306, some of which may be specific to a particular operating system or platform.

In an example, the applications 1306 include a home application 1336, a contacts application 1330, a browser application 1332, a book reader application 1334, a location application 1342, a media application 1344, a messaging application 1346, a game application 1348, and a broad assortment of other applications such as a third-party application 1340. According to some examples, the applications 1306 are programs that execute functions defined in the programs. Various programming languages can be employed to create one or more of the applications 1306, structured in a variety of manners, such as object-oriented programming languages (e.g., Objective-C, Java, or C++) or procedural programming languages (e.g., C or assembly language). In a specific example, the third-party application 1340 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1340 can invoke the API calls 1350 provided by the operating system 1312 to facilitate functionality described herein.

Various examples are contemplated. Example 1 is a method for acquiring head dimensions using a depth-sensing electronic device, the method comprising: capturing one or more images of a user's head positioned adjacent to a planar surface; extracting depth-related attributes of the user's head and the planar surface from the one or more images; applying machine learning models to interpret the extracted depth-related attributes and generate a three-dimensional model of the user's head; and determining specific head dimensions from the three-dimensional model.

In Example 2, the subject matter of Example 1 includes, wherein the machine learning models are trained on a diverse dataset of head dimensions encompassing varying ages, genders, ethnicities, and hair styles.

In Example 3, the subject matter of Examples 1-2 includes, preprocessing the one or more captured images to enhance the quality and accuracy of depth data before applying machine learning models.

In Example 4, the subject matter of Examples 2-3 includes, wherein the machine learning models further account for variability introduced by different hairstyles or hair types, thereby normalizing hair-induced deviations from an actual head shape.

In Example 5, the subject matter of Examples 1-4 includes, manufacturing a personalized head-worn product based on the specific head dimensions.

In Example 6, the subject matter of Examples 1-5 includes, recommending a size of a head-worn product based on the specific head dimensions.

In Example 7, the subject matter of Examples 1-6 includes, wherein the machine learning models account for ambient lighting conditions during image capture to adjust and enhance depth data processing.

In Example 8, the subject matter of Examples 1-7 includes, wherein the specific head dimensions are stored in a user profile, enabling subsequent retrievals for other personalized products or applications.

In Example 9, the subject matter of Examples 1-8 includes, a feedback mechanism where the user can add measurements and provide input on the accuracy of the specific head dimensions, allowing continuous improvement of the machine learning models.

In Example 10, the subject matter of Examples 1-9 includes, wherein wall distance loss optimization ensures that the back of the head's detected depth aligns with the planar surface's detected depth, providing a constraint for dimension extraction.

In Example 11, the subject matter of Examples 1-10 includes, a step of using augmented reality to overlay visual feedback on the user's device during the capturing process, aiding the user in achieving acceptable angles and positions.

In Example 12, the subject matter of Examples 1-11 includes, storing the specific head dimensions in a cloud-based system where they can be accessed and retrieved by authorized entities or applications.

In Example 13, the subject matter of Examples 1-12 includes, wherein the extracted depth-related attributes include a resolution parameter, allowing for scalability in processing based on a required precision of the specific head dimensions.

Example 14 is a system for acquiring head dimensions comprising: an electronic device with image capture capabilities; a user interface for instructing a user on image capture; at least one processor; at least one memory component storing instructions that, when executed by the at least one processor, cause the at least one processor to perform operations comprising: capturing one or more images of a user's head positioned adjacent to a planar surface; extracting depth-related attributes from the captured image(s); applying machine learning models to interpret the extracted depth-related attributes and generate a three-dimensional model of the user's head; and determining specific head dimensions from the three-dimensional model for manufacturing personalized products such as helmets.

In Example 15, the subject matter of Example 14 includes, wherein the machine learning models are trained on a diverse dataset of head dimensions encompassing varying ages, genders, ethnicities, hairstyles and hair types.

In Example 16, the subject matter of Examples 14-15 includes, wherein the acquired head dimensions are stored in a user profile, enabling subsequent retrievals for other personalized products or applications.

Example 17 is a non-transitory computer-readable medium having instructions stored thereon, which when executed by at least one processor, causes the at least one processor to perform operations comprising: capturing one or more images of a user's head positioned adjacent to a planar surface; extracting depth-related attributes from the captured image(s); applying machine learning models to interpret the extracted depth-related attributes and generate a three-dimensional model of the user's head; and determining specific head dimensions from the three-dimensional model for manufacturing personalized products such as helmets.

In Example 18, the subject matter of Example 17 includes, wherein the machine learning models are trained on a diverse dataset of head dimensions encompassing varying ages, genders, ethnicities, hairstyles, and hair types.

In Example 19, the subject matter of Examples 17-18 includes, wherein the specific head dimensions are stored in a user profile, enabling subsequent retrievals for other personalized products or applications.

In Example 20, the subject matter of Examples 17-19 includes, wherein the operations further comprise manufacturing a personalized head-worn product based on the specific head dimensions or recommending a size of a head-worn product based on the specific head dimensions.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20. Example 23 is a system to implement of any of Examples 1-20. Example 24 is a method to implement of any of Examples 1-20.

What is claimed is:

1. A method for acquiring head dimensions using a depth-sensing electronic device, the method comprising:
capturing one or more images of a user's head positioned adjacent to a planar surface;
extracting depth-related attributes of the user's head and the planar surface from the one or more images;
applying machine learning models to interpret the extracted depth-related attributes and generate a three-dimensional model of the user's head; and
determining specific head dimensions from the three-dimensional model.

2. The method of claim 1, wherein the machine learning models are trained on a diverse dataset of head dimensions including one or more attributes selected from the group consisting of varying ages, genders, ethnicities, hairstyles, hair types, and hair types.

3. The method of claim 1, further comprising preprocessing the one or more captured images to enhance the quality and accuracy of depth data before applying machine learning models.

4. The method of claim 1, wherein the machine learning models account for variability introduced by different hairstyles to normalize hair-induced deviations from an actual head shape.

5. The method of claim 1, further comprising manufacturing a personalized head-worn product based on the specific head dimensions.

6. The method of claim 1, further comprising recommending a size of a head-worn product based on the specific head dimensions.

7. The method of claim 1, wherein the machine learning models account for ambient lighting conditions during image capture to adjust and enhance depth data processing.

8. The method of claim 1, wherein the specific_head_dimensions are stored in a user profile, enabling subsequent retrievals for other personalized products or applications.

9. The method of claim 1, further comprising a feedback mechanism where the user can add measurements and provide input on the accuracy of the specific head dimensions, allowing continuous improvement of the machine learning models.

10. The method of claim 1, wherein wall distance loss optimization ensures that the back of the head's detected depth aligns with the planar surface's detected depth, providing a constraint for dimension extraction.

11. The method of claim 1, further comprising a step of using augmented reality to overlay visual feedback on the user's device during the capturing process, aiding the user in achieving acceptable angles and positions.

12. The method of claim 1, further comprising storing the specific head dimensions in a cloud-based system where they can be accessed and retrieved by authorized entities or applications.

13. The method of claim 1, wherein the extracted depth-related attributes include a resolution parameter, allowing for scalability in processing based on a required precision of the specific head dimensions.

14. A system for acquiring head dimensions comprising:
an electronic device with image capture capabilities;
a user interface for instructing a user on image capture;
at least one processor;
at least one memory component storing instructions that, when executed by the at least one processor, cause the at least one processor to perform operations comprising:
capturing one or more images of a user's head positioned adjacent to a planar surface;
extracting depth-related attributes from the captured image(s);
applying machine learning models to interpret the extracted depth-related attributes and generate a three-dimensional model of the user's head; and
determining specific head dimensions from the three-dimensional model for manufacturing personalized products such as helmets.

15. The system of claim 14, wherein the machine learning models are trained on a diverse dataset of head dimensions including one or more attributes selected from the group consisting of varying ages, genders, ethnicities, hairstyles, hair types, and hair types.

16. The system of claim 14, wherein the acquired head dimensions are stored in a user profile, enabling subsequent retrievals for other personalized products or applications.

17. A non-transitory computer-readable medium having instructions stored thereon, which when executed by at least one processor, causes the at least one processor to perform operations comprising:
capturing one or more images of a user's head positioned adjacent to a planar surface;
extracting depth-related attributes from the captured image(s);
applying machine learning models to interpret the extracted depth-related attributes and generate a three-dimensional model of the user's head; and
determining specific head dimensions from the three-dimensional model for manufacturing personalized products such as helmets.

18. The non-transitory computer-readable medium of claim 17, wherein the machine learning models are trained on a diverse dataset of head dimensions including one or more attributes selected from the group consisting of varying ages, genders, ethnicities, hairstyles, hair types, and hair types.

19. The non-transitory computer-readable medium of claim 17, wherein the specific head dimensions are stored in a user profile, enabling subsequent retrievals for other personalized products or applications.

20. The non-transitory computer-readable medium of claim 17, wherein the operations further comprise manufacturing a personalized head-worn product based on the specific head dimensions or recommending a size of a head-worn product based on the specific head dimensions.
